(19) United States
(12) Patent Application Publication
(10) Pub. No.: US 2010/0132966 A1
(43) Pub. Date: Jun. 3, 2010

(54) May-Ram

(76) Inventor: Paul Kevin Lawrence, Rowlett, TX (US)

Correspondence Address: PAUL K. LAWRENCE, 9110 WESTFIELD DR., ROWLETT, TX, 75088, US

(21) Appl. No.: 12/315,104

(22) Filed: Nov. 28, 2008

(51) Int. Cl. A62C 31/22

(52) U.S. Cl. 169/70

(57) ABSTRACT

The May-Ram is made of 1½″ aluminum pipe. It has fiber sleeve to help the firefighter from getting an electrical shock. This is a 6′ play pipe made out of 1½″ aluminum pipe. At the bottom end of the play pipe is a on/off Valve and at the top end is a Ram Head. It is light weight, so the firefighters can work with this tool with ease.

### FIELD OF THE INVENTION

The present invention relates to a firefighter being able to go threw a structure and pocking a hole in the ceiling were needed and putting water on a fire in the ceiling. The firefighter will be able to do this with ease and safety compared to the current method of pulling a peace sheetrock down and poking their head into the attic to see were a fire might be.

### A SUMMARY AND A BRIEF DESCRIPTION OF INVENTION

This is a tool for firefighters to use during the fighting of a fire. They will use it in a single level structure by pushing it threw the ceiling and opening the valve to let the water flow threw the play pipe, so it will put the water on the fire in the ceiling. This is a 6′ play pipe made out of 1½″ aluminum pipe. The May has fiber sleeve to help the fireman from getting an electrical shock. The May has a ram head, so the play pipe can be pushed threw the ceiling with ease.

The May-Ram is made of 1½″ aluminum pipe. It has fiber sleeves to help the fireman from getting an electrical shock. There is a ram head on the top of the May-Ram to help pock a hole into the ceiling, so the spraying of the solvent onto the fire.

The play pipe will allow instant access to attic, walls etc by punching a hole in sheetrock in needed areas without the need of setting ladders.

### BRIEF DESCRIPTION OF THE DRAWINGS

FIG. 1 shows a view of the May Ram-head.

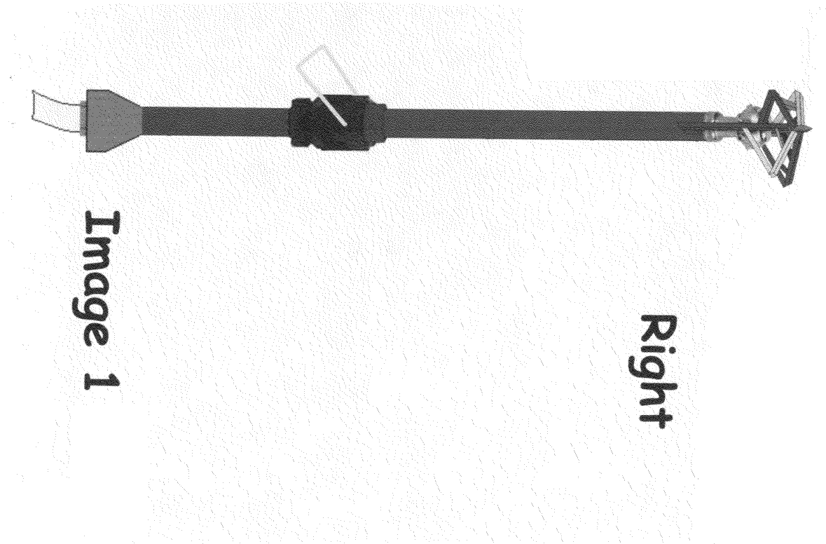

FIG. 2 is the right view of the tool.

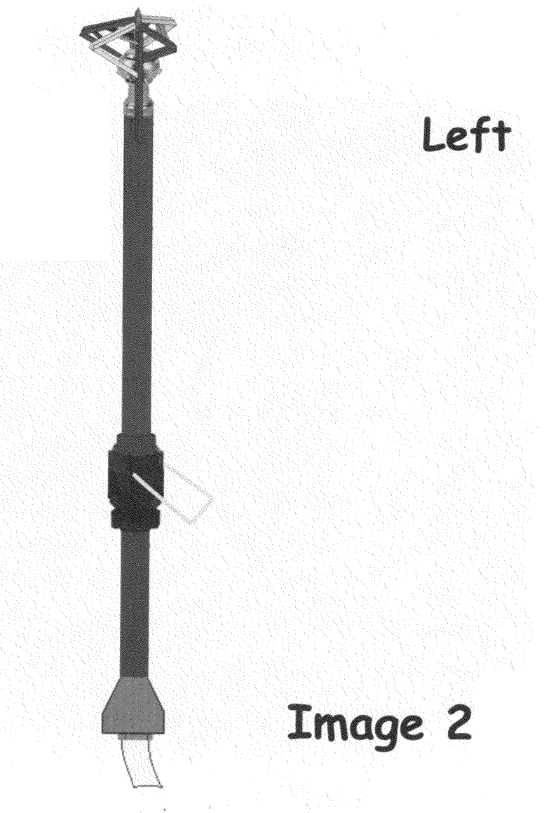

FIG. 3 is the left view of the tool.

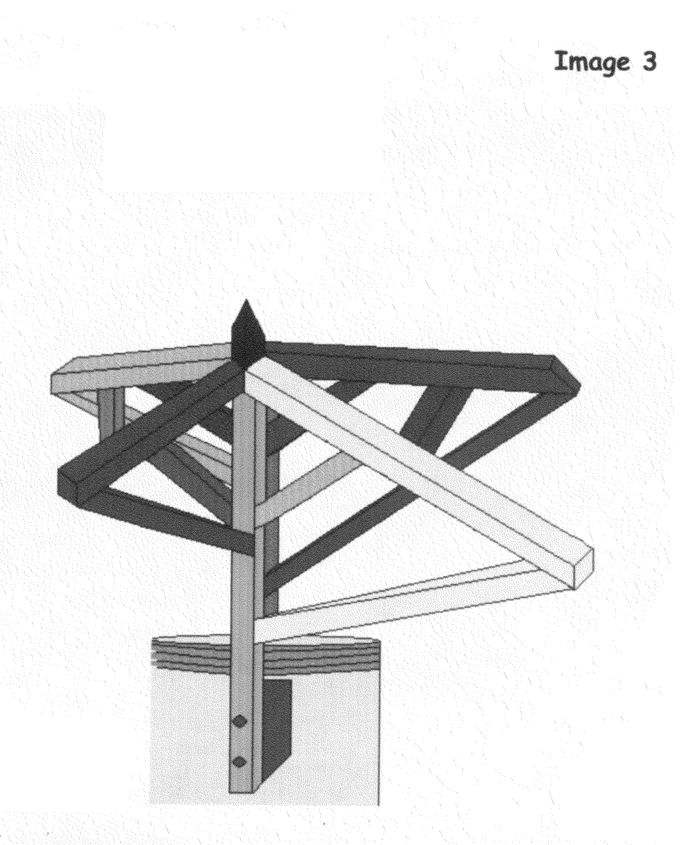

### DESCRIPTION OF THE PREFERRED EMBODIMENT AND A DETAIL DESCRIPTION OF INVENTION

As to the manner of usage and operation of the invention it is preferred to be used by a firefighter to use during the fighting of a fire. They will use it in a single level structure or multi level structure by pushing it threw the ceiling and opening the valve to let the water flow threw the play pipe, so it will put the water on the fire in the ceiling. The May has a ram head that makes pushing the play pipe threw the ceiling easy.

Used a 1½″ aluminum pipe 5′ long and 1½″ long American standard threads on both ends of the Play Pipe one being male thread joint the other being female threaded joint. Push a fiberglass sleeve that is 24″ long and one end is flared were it can go over the female end onto the play pipe over a male end and push it over the female end. Attach the fiberglass sleeve to the play pipe. Then screw an on/off valve onto the female thread joint end the same as the fiberglass sleeve. On the other end of the play pipe attach the ram head on the male threaded joint. Screw a cellar nozzle onto the end that the ram head is on. Push a fiberglass sleeve 10.5″ long onto a peace of 1½″ aluminum pipe 12″ long with American standard threads 1½″ long both ends being male. Attach the fiberglass sleeve to the play pipe. Put a rubber boot over the same end 1½″ up from the end of the pipe and screw the other end into the valve on the peace of pipe you were just working with. Attach the rubber boot to the play pipe.

What is claimed is:

1. This will help a fireman from getting into an emergency by keeping the Fireman from having to pock their head up in the ceiling of a burring structure. This will also ad the Fireman in which the Fireman can extinct the fire of a burring structure, by allowing them to go to the necessary rooms and quickly pocking the May into the ceiling and applying the needed solvent onto the burring materiel.
